(19) United States
(12) Patent Application Publication
(10) Pub. No.: US 2003/0197056 A1
(43) Pub. Date: Oct. 23, 2003

(54) Identification card printer data encoder module

(76) Inventors: Matthew K. Dunham, Eagan, MN (US); Darrell T. Olson, Minnetonka, MN (US)

Correspondence Address: WESTMAN, CHAMPLIN & KELLY, A PROFESSIONAL ASSOCIATION, SUITE 1600 - INTERNATIONAL CENTRE, 900 SECOND AVENUE SOUTH, MINNEAPOLIS, MN, 55402-3319, US

(21) Appl. No.: 10/126,440

(22) Filed: Apr. 19, 2002

(51) Int. Cl. G06K 5/00

(52) U.S. Cl. 235/380

(57) ABSTRACT

A data encoder module includes a card feeder and an encoding component. The card feeder is adapted to receive a card from an out-feed component of a transport mechanism and move the card within an encoding plane. The encoding plane is oriented such that the card is free to move toward the out-feed component a distance that is greater than a distance separating the out-feed component and the card feeder without contacting the out-feed component. The encoding component is adapted to encode data to the card.

### CROSS REFERENCE TO RELATED APPLICATIONS

Reference is hereby made to the following related co-pending applications filed on even date herewith: application Ser. No. 10/______, entitled “IDENTIFICATION CARD PRINTER HAVING MULTIPLE CONTROLLERS,” for inventors Gary W. Klinefelter, Leonid S. Gershenovich, Gary A. Lenz; and Robert E. Francis, having Attorney Docket Number F12.12-0109; application Ser. No. 10/______, entitled “IDENTIFICATION CARD PRINTER,” for inventors Martin A. Pribula, James R. Meier, Stacy W. Lukaskawcez, Gary M. Klinefelter, Leonid S. Gershenovich, Gary A. Lenz, and Jeffrey D. Upin, having Attorney Docket Number F12.12-0110; application Ser. No. 10/______, entitled “CARD CARTRIDGE,” for inventors Martin A. Pribula, James M. Meier, Stacy W. Lukaskawcez, Anthony L. Lokken, Gary M. Klinefelter, Gary A. Lenz and Jeffrey D. Upin, having Attorney Docket Number F12.12-0111; application Ser. No. 10/______, entitled “CARD TRANSPORT MECHANISM ROLLER SUPPORT,” for inventors Martin A. Pribula and Gary M. Klinefelter, having Attorney Docket Number F12.12-0112; and application Ser. No. 10/______, entitled “CARD CARTRIDGE AND CARD FEEDER ADAPTER FOR AN INK JET SHEET FEEDER PRINTER,” for inventors Gary M. Klinefelter, Martin A. Pribula, Leonid S. Gershenovich and Stacy W. Lukaskawcez, having Attorney Docket Number F12.12-0113. All of the above-referenced applications are incorporated herein by reference in their entirety.

### FIELD OF THE INVENTION

The present invention relates to identification card printers and, more particularly, to a magnetic encoding module for use with an identification card printer.

### BACKGROUND OF THE INVENTION

Identification card printers along with the aid of a computer are typically used to form identification cards by printing an image on a card substrate. The image generally includes a photograph and other information relating to the card holder, such as the card holder's name, employee number, and other information. Such identification cards are used for many purposes, such as driver's licenses, identification badges, etc. The image that is to be printed on the card by the identification card printer is generally formed by combining textual and graphical portions received from host applications running on the computer or from other input devices such as keyboards, scanners, and digital cameras. Data relating to the formatted image is then provided to the printer in the form of a print job. The printer processes the print job by printing the image onto a surface of the card.

Typical identification card printers include a print mechanism, a transport mechanism, and a card holder. For thermal-based identification card printers, the print mechanism can include a thermal print ribbon having primary colored dye panels and a thermal print head. The thermal print head heats the ribbon and causes dye on the color panels to be released and sublimate into a surface of the card. Alternatively, the identification card printer can be an ink jet printer that includes an ink jet print head having a supply of ink. The transport mechanism is generally configured to transport cards from the card holder to the print mechanism for printing.

Identification cards are also commonly configured to contain data stored either in a magnetic strip or in an embedded chip that is encoded using a data encoder. Data can be written to the magnetic strips using a magnetic encoder and to the chip with a smart card encoder. Magnetic encoders generally include a magnetic write head for writing the desired data to the magnetic portion or strip on the card. Smart card encoders encode data to chips of smart cards through direct electrical contact or through radio frequency (RF) communication methods. The components of the encoder are typically controlled by the controller of the identification card printer that also operates to control the print mechanism, transport mechanism, and other components of the printer. The printer controller also provides the data that is to be encoded by the data encoder.

The magnetic encoding of data onto the magnetic strip of the card generally involves aligning the magnetic write head with a leading edge of the magnetic strip. Next, data is magnetically written to the magnetic strip with the magnetic write head as the card feeder feeds the card over the magnetic write head. Prior to reaching a trailing edge of the magnetic strip, the magnetic write head stops writing data to complete the processing of the card. The card can then be discharged to an output hopper or provided to another component for further processing.

It is generally desirable to incorporate a data encoder within an identification card printer or allow for the attachment of the data encoder to the identification card printer. In either configuration, an out-feed component of the transport mechanism of the identification card printer, or other card feeding component, delivers the card to a card feeder of the data encoder for processing.

In accordance with conventional magnetic encoding methods, the distance separating the out-feed component of the transport mechanism and the card feeder of the magnetic encoder is nearly the length of the card being processed. This is due to problems that occur when the card contacts the out-feed component of the transport mechanism during the writing of data to the card. In particular, the card vibrates slightly when it comes into contact with another transport mechanism component, which interferes with the writing of data to the magnetic strip thereby potentially making it unreadable. As a result, no data is written to the trailing and leading edge portions of the magnetic strip over which the magnetic write head is positioned when the card comes into contact with a transport mechanism component. These portions or margins of the magnetic strip are typically approximately 0.3 inches at the leading and trailing edges of the card. As a result, typical magnetic encoders separate the card feeder mechanism of the magnetic encoder and the transport mechanism components by the largest distance possible, which is substantially the length of the card to maximize the length of the magnetic strip over which data can be reliably written.

There is a continuing need for improvements to identification card printers having data encoders. In particular, it would be desirable to reduce the distance between the out-feed component of the transport mechanism and the card feeder of the data encoder in order to reduce the size of the identification card printer. Furthermore, it would be desirable to make this distance reduction without affecting the length of the magnetic strip that can be encoded by a magnetic encoder.

### SUMMARY OF THE INVENTION

The present invention is directed to a data encoder module for use in an identification card printer that can be positioned in close proximity to an out-feed component of a transport mechanism. The data encoder module includes a card feeder and an encoding component. The card feeder is adapted to receive a card from an out-feed component of a transport mechanism and move the card within an encoding plane. The encoding plane is oriented such that the card is free to move toward the out-feed component a distance that is greater than a distance separating the out-feed component and the card feeder without contacting the out-feed component. The encoding component is adapted to encode data to the card.

Other features and benefits that characterize embodiments of the present invention will be apparent upon reading the following detailed description and review of the associated drawings.

### BRIEF DESCRIPTION OF THE DRAWINGS

FIGS. 1 and 2 are perspective views of examples of an identification card printer respectively with and without a cover, with which embodiments of the present invention can be used.

FIG. 3 is a perspective view of an identification card printer with an installed magnetic encoder module in accordance with embodiments of the invention.

FIGS. 4 and 5 respectively show front and rear perspective views of a magnetic encoder module in accordance with embodiments of the invention.

FIG. 6 is a schematic illustration of a magnetic write head positioned to encode data to a magnetic portion of the card in accordance with an embodiment of the invention.

FIGS. 7 and 8 are simplified side cross-sectional views of a magnetic encoder module and an out-feed component of a transport mechanism taken generally along a line A-A of FIG. 3.

### DETAILED DESCRIPTION OF THE PREFERRED EMBODIMENTS

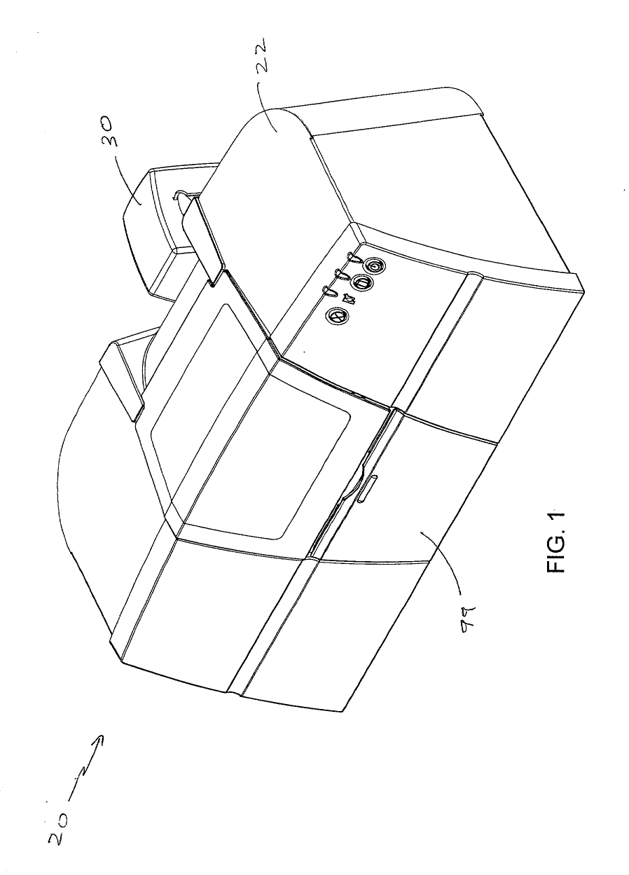

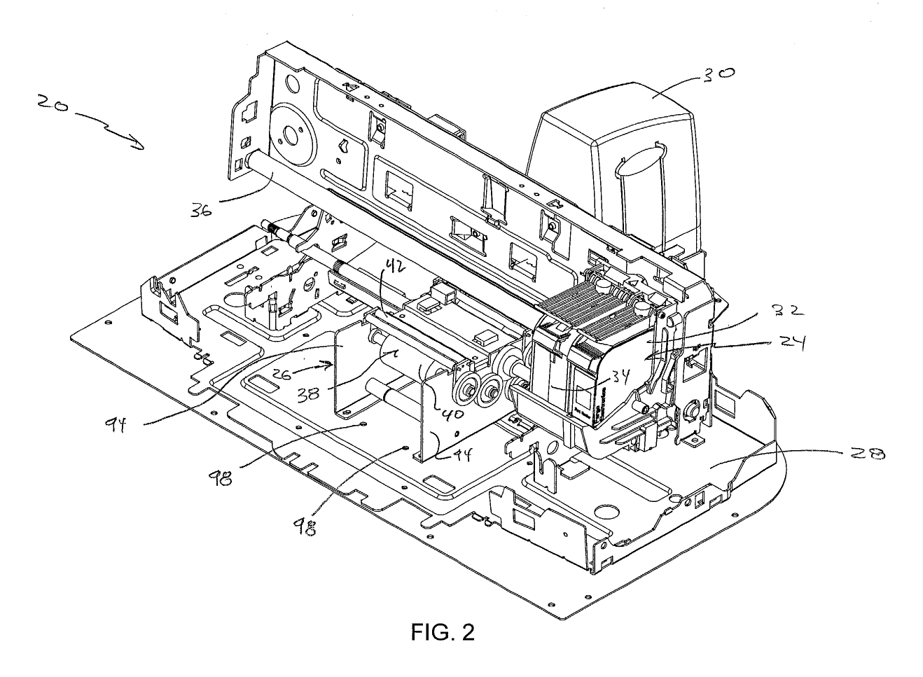

FIGS. 1 and 2 are perspective views of an example of an identification card printer 20 respectively with and without a cover 22, with which embodiments of the present invention can be used. Printer 20 generally includes a print mechanism 24, a transport mechanism 26, a base 28 and a printer controller (not shown) that controls the operation of the components of printer 20. Printer 20 can receive cards for processing from a card cartridge 30 and deliver the cards to print mechanism 24 for printing using transport mechanism 26.

Print mechanism 24 is depicted as an ink jet printhead having color and black ink jet cartridges 32 and 34, as shown in FIG. 2. Print mechanism 24 can also be a thermal printhead in combination with a thermal print ribbon, or other suitable print mechanism. Print mechanism 24 is generally moved back and forth along rail 36 in a direction that is transverse to the card path along which transport mechanism 26 feeds the cards. Print mechanism 24 prints image lines on cards that are presented in a print position by transport mechanism 26 to form the desired image.

Once the printing is complete, the printed card can be discharged into a card hopper or other card processing device by an out-feed component 38. One embodiment of out-feed component 38 is a dual pinch feed roller assembly that includes a bottom feed roller 40 and two top guide rollers 42.

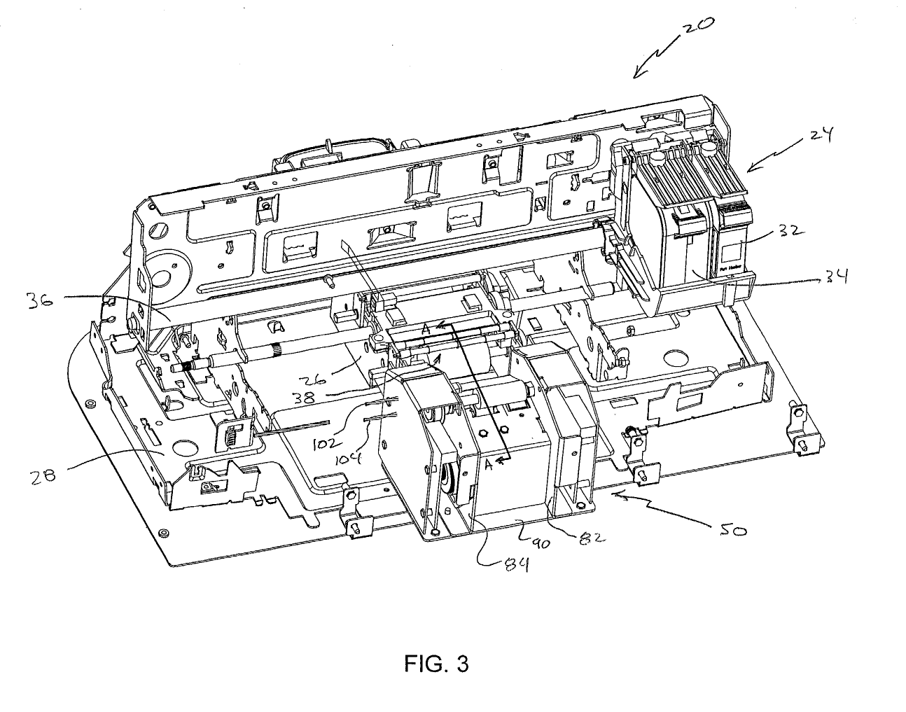

The present invention relates to a data encoder module 50 that is adapted to be installed as a component of printer 20, as shown in FIG. 3, and encode data to a card being processed by printer 20. Data encoder module 50 can be a smart card encoder having a chip encoding component, a magnetic encoder having a magnetic encoding head, or other type of data encoder. In accordance with one aspect of the invention, data encoder module 50 allows printer 20 to be formed more compactly than prior art printers having data encoders. To simplify the discussion of the present invention, data encoder module 50 will hereinafter be described as a magnetic encoder module 50, which further benefits from the present invention by reducing data encoding errors on the card that result when the card comes into contact with out-feed component 38 of transport mechanism 26.

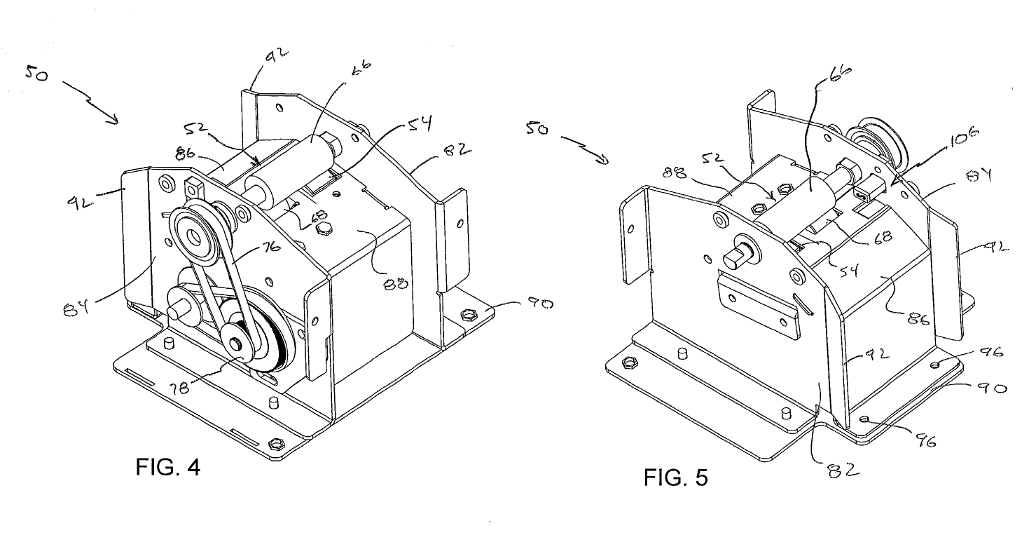

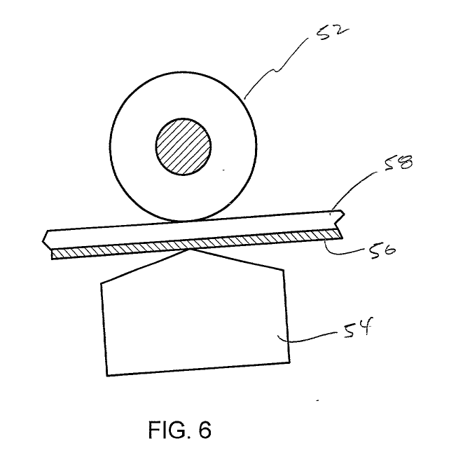

Magnetic encoder module 50 that is installable to base 28 immediately in front of out-feed component 38 of transport mechanism 26, as shown in FIG. 3. FIGS. 4 and 5 respectively show front and rear perspective views of magnetic encoder module 50, in accordance with the present invention. Magnetic encoder module 50 includes a card feeder 52 and a magnetic write head 54. Magnetic write head 54 is positioned to magnetically encode data on a magnetic portion 56 of a card 58 as card 58 is fed within the encoding plane by card feeder 52, as illustrated schematically in FIG. 6.

In accordance with one aspect of the present invention, card feeder 52 is adapted to receive a card from out-feed component 38 of transport mechanism 26 and move the card forward, or in a downstream direction, away from out-feed component 38 and rearward, or in an upstream direction, toward the out-feed component 38 in an encoding plane. The encoding plane is oriented such that the card is free to move toward the out-feed component 38 a distance that is greater than the distance separating the out-feed component 38 and card feeder 52 without contacting out-feed component 38. This aspect of the present invention allows distance D to be substantially less than the length (typically 3.375 inches) of card 58 resulting in a reduction to the length of printer 20 as compared to prior art configurations that separate the card feeder and out-feed components by approximately the length of the card. Additionally, this aspect of the present invention allows encoder module 50 to operate independent of transport mechanism 26 since card feeder 52 provides the desired control of the card without reliance on out-feed component 38.

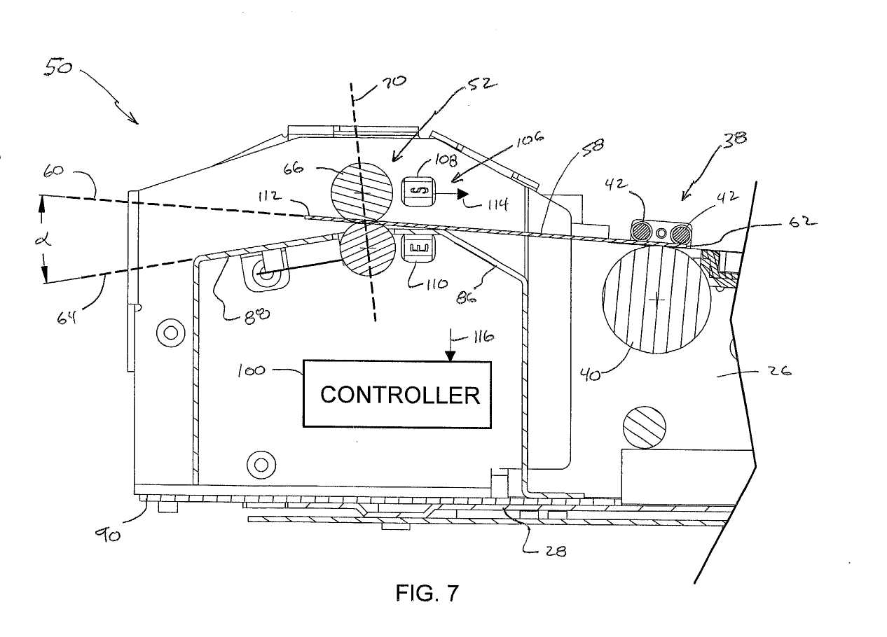

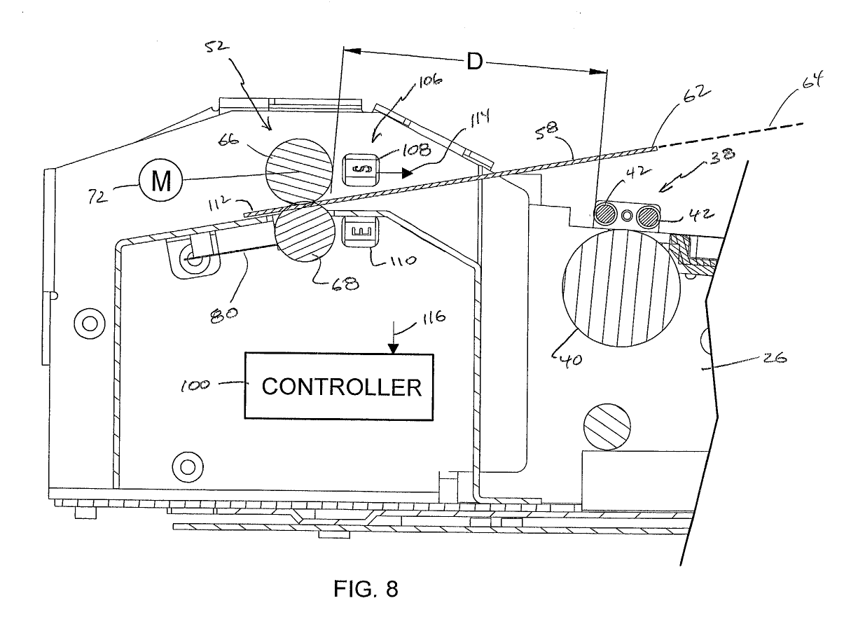

FIGS. 7 and 8 are simplified side cross-sectional views of magnetic encoder module 50 taken generally along line A-A of FIG. 3. With reference to FIG. 7, card feeder 52 is adapted to receive a card 58 from out-feed component 38 that is generally aligned in a card transport plane 60. Once a trailing edge 62 of card 58 is fed out of out-feed component 38, card 58 is allowed to pivot and align with encoding plane 64, as shown in FIG. 8. Card feeder 52 can then move card 58 rearwardly toward out-feed component 38 a distance that is greater than the distance D separating card feeder 52 from out-feed component 38 without contacting out-feed component 38, as shown in FIG. 8. The distance D (FIG. 8) and angle α (FIG. 7), between card transport plane 60 and encoding plane 64 can be set in accordance with the specific configuration of the card feeder 52 and out-feed component 38. In accordance with a preferred embodiment, the distance D is approximately 2.5 inches and the angle α is approximately 10°.

One embodiment of card feeder 52 is a single pinch roller assembly that includes top and bottom feed rollers 66 and 68, respectively, as shown in FIGS. 5, 7 and 8. The axes of rotation of top and bottom feed rollers 66 and 68 are aligned in a pinch roller plane 70, shown in FIG. 7. The pinch roller plane 70 determines the encoding plane 60, which is perpendicular thereto. Magnetic write head 54 is positioned substantially in the pinch roller plane 70 adjacent bottom feed roller 68 and below top feed roller 66, as shown in FIG. 4. Top feed roller 66 is preferably driven by a stepper motor 72 (shown schematically in FIG. 8) through a suitable connection. For example, top feed roller 66 can be driven by a belt 76 that mounts to a pulley 78 that is driven by motor 72, as shown in FIG. 4. In accordance with this configuration, the bottom feed roller 68 operates as an idler roller. Thus, top feed roller 66 controls the receipt of card 58 from out-feed component 38 and the movement of card 58 in encoding plane 64.

In order to accommodate the receipt of cards 58 in card transport plane 60 and to provide a secure “pinch” of card 58 between top and bottom feed rollers 66 and 68, bottom feed roller 68 is preferably deflectable in a downward direction and is spring-loaded toward the top feed roller 66 by way of a suitable biasing mechanism. The biasing mechanism can include, for example, spring member 80 that mounts to an axle of bottom feed roller 68 and applies a force to direct bottom feed roller 68 toward top feed roller 66, as shown in FIG. 8. It is further preferred that magnetic write head 54 have a similar biasing mechanism to maintain magnetic write head 54 against card 58 (FIG. 6) as card 58 is fed by card feeder 52 within encoding plane 64.

Magnetic encoding module 50 can also include side walls 82 and 84, in-feed and out-feed ramps 86 and 88, and a base plate 90 to which side walls 82 and 84 are mounted, as shown in FIGS. 4 and 5. Out-feed ramp 88 is preferably aligned with the encoding plane 64, as shown in FIG. 7. Alignment of magnetic encoder module 50 to transport mechanism 26 is assisted by guide tabs 92, which engage side walls 94 of transport mechanism 26 and guide cards toward card feeder 52 of magnetic encoder module 50 along with in-feed ramp 86. Additionally, base plate 90 includes apertures 96 (FIG. 5) that align with threaded apertures 98 (FIG. 2) of base 28 and receive screws to secure magnetic encoder module 50 to base 28. When installed, magnetic encoding module 50 is partially enclosed in printer 20. This simplifies the installation of encoder module 50 and results in a minimal expansion of the size of printer 20. The portion of magnetic encoder module 50 that protrudes from the interior of printer 20 is accommodated by opening door 99 of printer cover 22, shown in FIG. 1.

Magnetic encoder module 50 can be operated by the printer controller (not shown) that is used to control the components of identification card printer 20 including the print and transport mechanisms 24 and 26. Alternatively, magnetic encoder module 50 can include an independent controller 100 (shown schematically in FIGS. 7 and 8) that receives command signals and data from a personal computer, or the printer controller, through a Universal Serial Bus (USB) connection 102, shown in FIG. 3, which allows magnetic encoder module 50 to be operated independently of the other components of printer 20. Power for the components of magnetic encoder module 50 can be provided through a separate connection 104 (FIG. 3) having a voltage of 18 volts, for example. Preferably, a single plug-in connection, such as an 8-pin connection, provides both the USB connection 102 and power connection 104 to simplify the installation of magnetic encoder module 50. Controller 100 preferably has a unique network address to which the command signals and data are sent for direct communication of those signals to magnetic encoder module 50. This allows the separate printer controller to also connect to the USB network through an appropriate hub and have its own address for receiving command signals and data relating to the printing of cards.

Magnetic encoder module 50 also includes a sensor 106, shown in FIGS. 5, 7 and 8, on an upstream side of card feeder 52 that is configured to detect the presence or absence of a card 58. In accordance with one embodiment, card sensor 106 mounts to sidewall 84 and includes a phototransistor 108 and an infrared light emitting diode (LED) 110 that are positioned on opposite sides of the card path (i.e., the card transport plane and the encoding plane) along which cards 58 are received and fed by card feeder 52. Infrared LED 110 emits an infrared signal that is directed to phototransistor 108. Phototransistor 108 can sense the presence of a card 58 when the infrared signal is interrupted by a card 58 fed between infrared LED 110 and phototransistor 108.

In operation, sensor 106 is configured to initially sense a leading edge 112 of a card 58 as it is received from out-feed component 38 of transport mechanism 26. Sensor 106 includes an output signal (depicted as arrow 114) that indicates the detection of the leading edge 112 of card 58. The output signal 114 is received by controller 100, as indicated by arrow 116, which then operates the stepper motor 72 to drive top feed roller 66 and pull card 58 forward, as illustrated in FIG. 7. After card 58 is pulled through the out-feed component 38 of transport mechanism 26, card 58 is pivoted to the encoding plane 64 by card feeder 52 due to the orientation of top and bottom feed rollers 66 and 68. Card 58 is then fed forward along encoding plane 64 until sensor 106 detects trailing edge 62 of card 58. During this feeding operation, the steps of stepper motor 72 driving top feed roller 66 are counted to provide card length information to controller 100 for use during the feeding of card 58 back and forth along encoding plane 64 during forthcoming magnetic encoding operations. Thus, sensor 106 is a card length sensor as well as a card presence sensor. Finally, magnetic write head 54 is controlled by controller 100 to write data to magnetic portion 56 of card 58 as it is fed rearwardly along encoding plane 64 back toward out-feed component 38. Due to the orientation of encoding plane 64, card 58 can be fed a distance that exceeds the distance D separating card feeder 52 from out-feed component 38 without having card 58 contact out-feed component 38, which could adversely affect the data encoded by magnetic write head 54. The locations along the card 58 where magnetic write head 54 begins and ends magnetically encoding data in magnetic portion or strip 56, are accurately controlled by counting the steps of stepper motor 72 in accordance with the card length information obtained in the initial feeding of card 58. In accordance with one embodiment card 58 is fed forward along the encoding plane by card feeder 52 and the written or encoded data is verified by reading the encoded data using magnetic write head 54 (set in a read mode) or by using a separate magnetic read head to ensure that it matches the data that was intended to be encoded in the writing step.

Although the present invention has been described with reference to preferred embodiments, workers skilled in the art will recognize that changes may be made in form and detail without departing from the spirit and scope of the invention.

What is claimed is:

1. A data encoder module for use in an identification card printer comprising:
a card feeder that is adapted to receive a card from an out-feed component of a transport mechanism and move the card within an encoding plane, the encoding plane oriented such that the card is free to move toward the out-feed component a distance that is greater than a distance separating the out-feed component and the card feeder without contacting the out-feed component; and
an encoding component adapted to encode data to the card.

2. The data encoder module of claim 1, wherein the encoding component is a magnetic write head adjacent the card feeder and configured to encode data on a magnetic portion of the card as the card feeder moves the card in the encoding plane.

3. The data encoder of claim 1, wherein the encoding component is a smart card chip encoder.

4. The data encoder module of claim 1, wherein the card feeder includes top and bottom feed rollers, the feed rollers having axes of rotation that are aligned in a pinch roller plane that is substantially perpendicular to the encoding plane.

5. The data encoder module of claim 1, including a controller adapted to control the card feeder and the encoding component.

6. The data encoder module of claim 5, wherein the controller is connectable to a Universal Serial Bus (USB) network.

7. The data encoder module of claim 4, wherein the bottom feed roller is driven by a motor that is controlled by a controller.

8. The data encoder module of claim 7, wherein the motor is a stepper motor.

9. The data encoder module of claim 4, wherein:
the bottom feed roller is deflectable downwardly from the top feed roller; and
the card feeder includes a biasing mechanism adapted to apply a force to the bottom feed roller to direct the bottom feed roller toward the top feed roller.

10. The data encoder module of claim 4, wherein the encoding component is positioned substantially in the pinch roller plane adjacent the bottom feed roller and below the top feed roller.

11. The data encoder module of claim 1, wherein the encoding component receives write signals from a controller and responsively encodes data to the card in accordance with the write signals.

12. The data encoder module of claim 1, including a card sensor adjacent the card feeder, the card sensor having an output signal indicating the detection of a card fed from the out-feed component.

13. The data encoder module of claim 12, including a controller adapted to control the operation of the card feeder in response to the output signal.

14. An identification card printer comprising:
a supply of cards;
a print mechanism for printing on cards;
a transport mechanism for transporting cards from the supply of cards to the print mechanism for printing, the transport mechanism having a card out-feed component downstream of the print mechanism; and
a data encoder module comprising:
a card feeder that is adapted to receive a card from an out-feed component of a transport mechanism and move the card within an encoding plane, the encoding plane oriented such that the card is free to move toward the out-feed component a distance that is greater than a distance separating the out-feed component and the card feeder without contacting the out-feed component; and
an encoding component adapted to encode data to the card.

15. The data encoder module of claim 14, wherein the encoding component is a magnetic write head adjacent the card feeder and configured to encode data on a magnetic portion of the card as the card feeder moves the card in the encoding plane.

16. The data encoder of claim 14, wherein the encoding component is a smart card chip encoder.

17. The data encoder module of claim 14, wherein the card feeder includes top and bottom feed rollers, the feed rollers having axes of rotation that are aligned in a pinch roller plane that is substantially perpendicular to the encoding plane.

18. The data encoder module of claim 14, including a controller adapted to control the card feeder and the encoding component.

19. The data encoder module of claim 18, wherein the controller is connectable to a Universal Serial Bus (USB) network.

20. The data encoder module of claim 17, wherein the bottom feed roller is driven by a motor that is controlled by a controller.

21. The data encoder module of claim 20, wherein the motor is a stepper motor.

22. The data encoder module of claim 17, wherein:
the bottom feed roller is deflectable downwardly from the top feed roller; and
the card feeder includes a biasing mechanism adapted to apply a force to the bottom feed roller to direct the bottom feed roller toward the top feed roller.

23. The data encoder module of claim 17, wherein the encoding component is positioned substantially in the pinch roller plane adjacent the bottom feed roller and below the top feed roller.

24. The data encoder module of claim 14, wherein the encoding component receives write signals from a controller and responsively encodes data to the card in accordance with the write signals.

25. The data encoder module of claim 14, including a card sensor adjacent the card feeder, the card sensor having an output signal indicating the detection of a card fed from the out-feed component.

26. The data encoder module of claim 25, including a controller adapted to control the operation of the card feeder in response to the output signal.

27. A magnetic encoder module for use in an identification card printer comprising:
a card feeder that is adapted to receive a card from an out-feed component of a transport mechanism and move the card within an encoding plane, the encoding plane oriented such that the card is free to move toward the out-feed component a distance that is greater than a distance separating the out-feed component and the card feeder without contacting the out-feed component; and
a magnetic write head adjacent the card feeder and positioned to encode data on a magnetic portion of the card as the card feeder moves the card in the encoding plane.

28. The magnetic encoder module of claim 27, wherein the card feeder includes top and bottom feed rollers, the feed rollers having axes of rotation that are aligned in a pinch roller plane that is substantially perpendicular to the encoding plane.

29. The magnetic encoder module of claim 28, including a controller adapted to control the card feeder and the magnetic write head.

30. The magnetic encoder module of claim 29, wherein the controller is connectable to a Universal Serial Bus (USB) network.

31. The magnetic encoder module of claim 28, wherein the bottom feed roller is driven by a motor that is controlled by a controller.

32. The magnetic encoder module of claim 31, wherein the motor is a stepper motor.

33. The magnetic encoder module of claim 28, wherein:
the bottom feed roller is deflectable downwardly from the top feed roller; and
the card feeder includes a biasing mechanism adapted to apply a force to the bottom feed roller to direct the bottom feed roller toward the top feed roller.

34. The magnetic encoder module of claim 28, wherein the magnetic write head is positioned substantially in the pinch roller plane adjacent the bottom feed roller and below the top feed roller.

35. The magnetic encoder module of claim 27, wherein the magnetic write head receives write signals from a controller and responsively produces a magnetic field in accordance with the write signals.

36. The magnetic encoder module of claim 27, including a card sensor positioned on an upstream side of the card feeder and having an output signal indicating the detection of a card fed from the out-feed component.

37. The magnetic encoder module of claim 36, including a controller adapted to control the operation of the card feeder in response to the output signal.

38. The magnetic encoder module of claim 27, including:
an in-feed ramp located on an upstream side of the card feeder; and
an out-feed ramp positioned on a downstream side of the card feeder and substantially parallel with the encoding plane.

39. The magnetic encoder module of claim 38, including side walls adjacent the in-feed ramp.

40. A magnetic encoder module for use with an identification card printer comprising:
a card feeder including top and bottom feed rollers, the feed rollers having axes of rotation that are aligned in a pinch roller plane, the pinch roller assembly configured to control the position of a card in an encoding plane that is angularly displaced from a card transport plane in which cards are provided from an out-feed component of a transport mechanism;
a magnetic write head adjacent the card feeder and positioned to encode data on magnetic portions of the cards;
a card sensor positioned on an upstream side of the card feeder and having an output signal indicating the detection of a card fed from the out-feed component; and
a controller in electrical communication with the output signal and adapted to control the card feeder and the magnetic write head.

41. The magnetic encoder module of claim 40, wherein the bottom feed roller is driven by a motor.

42. The magnetic encoder module of claim 41, wherein the motor is a stepper motor.

43. The magnetic encoder module of claim 40, wherein:
the bottom feed roller is deflectable downwardly from the top feed roller; and
the card feeder includes a biasing mechanism adapted to apply a force to the bottom feed roller to direct the bottom feed roller toward the top feed roller.

44. The magnetic encoder module of claim 40, wherein the magnetic write head is positioned substantially in the pinch roller plane adjacent the bottom feed roller and below the top feed roller.

45. The magnetic encoder module of claim 40, wherein the magnetic write head receives write signals from the controller and responsively produces a magnetic field in accordance with the write signals.

46. The magnetic encoder module of claim 40, including:
an in-feed ramp located on an upstream side of the card feeder; and
an out-feed ramp positioned on a downstream side of the card feeder and substantially parallel with the encoding plane.

47. The magnetic encoder module of claim 46, including side walls adjacent the in-feed ramp.

48. The magnetic encoder module of claim 40, including a magnetic read head.

49. An identification card printer comprising:
a supply of cards;
a print mechanism for printing on cards;
a transport mechanism for transporting cards from the supply of cards to the print mechanism for printing, the transport mechanism having a card out-feed component downstream of the print mechanism; and
a magnetic encoder module adjacent the out-feed component comprising:
a card feeder that is adapted to receive a card from the out-feed component and move the card within an encoding plane, the encoding plane oriented such that the card is free to move toward the out-feed component a distance that is greater than a distance separating the out-feed component and the card feeder without contacting the out-feed component; and
a magnetic write head adjacent the card feeder and positioned to encode data on a magnetic portion of the card as the card feeder moves the card in the encoding plane.

50. The magnetic encoder module of claim 49, wherein the card feeder includes top and bottom feed rollers, the feed rollers having axes of rotation that are aligned in a pinch roller plane that is substantially perpendicular to the encoding plane.

51. The magnetic encoder module of claim 50, including a controller adapted to control the card feeder and the magnetic write head.

52. The magnetic encoder module of claim 51, wherein the controller is connectable to a Universal Serial Bus (USB) network.

53. The magnetic encoder module of claim 50, wherein the bottom feed roller is driven by a motor that is controlled by a controller.

54. The magnetic encoder module of claim 53, wherein the motor is a stepper motor.

55. The magnetic encoder module of claim 50, wherein:
the bottom feed roller is deflectable downwardly from the top feed roller; and
the card feeder includes a biasing mechanism adapted to apply a force to the bottom feed roller to direct the bottom feed roller toward the top feed roller.

56. The magnetic encoder module of claim 50, wherein the magnetic write head is positioned substantially in the pinch roller plane adjacent the bottom feed roller and below the top feed roller.

57. The magnetic encoder module of claim 49, wherein the magnetic write head receives write signals from a controller and responsively produces a magnetic field in accordance with the write signals.

58. The magnetic encoder module of claim 49, including a card sensor positioned on an upstream side of the card feeder and having an output signal indicating the detection of a card fed from the out-feed component.

59. The magnetic encoder module of claim 58, including a controller adapted to control the operation of the card feeder in response to the output signal.

60. The magnetic encoder module of claim 49, including:
an in-feed ramp located on an upstream side of the card feeder; and
an out-feed ramp positioned on a downstream side of the card feeder and substantially parallel with the encoding plane.

61. The magnetic encoder module of claim 50, including side walls adjacent the in-feed ramp.

62. The identification card printer of claim 49, including a base to which the transport mechanism and the magnetic encoder module are mounted.

63. The identification card printer of claim 49, wherein the out-feed component of the transport mechanism includes at least one top guide roller and a bottom feed roller.

64. The identification card printer of claim 49, wherein the supply of cards is contained in a card cartridge comprising a housing having an interior cavity that is sized to accommodate a stack of cards, the housing including a pair of opposing side walls, a top, a front wall, a back wall opposite the front wall, a base, a card access, through which a card transport mechanism can engage a lead card, and a card output slot.

65. A method of encoding a magnetic portion of a card, the method comprising steps of:
(a) receiving the card from an out-feed component of a transport mechanism;
(b) pivoting the card into an encoding plane;
(c) feeding the card forward along the encoding plane;
(d) writing data to the magnetic portion of the card as the card is fed rearwardly along the encoding plane.

66. The method of claim 65, including steps of:
(e) reading the encoded data on the magnetic portion as the card is fed forwardly along the encoding plane; and
(f) verifying that the data encoded on the magnetic portion matches the data intended to be written in step (e) to the magnetic portion.

67. The method of claim 66, including steps of:
(g) dispensing the card when the encoded data is valid; and
(h) holding the card and/or producing a signal when the encoded data is invalid.
